(19) United States
(12) Patent Application Publication
(10) Pub. No.: US 2024/0264830 A1
(43) Pub. Date: Aug. 8, 2024

(54) AUTOMATED PROJECT MANAGEMENT USING CONVERSATIONAL PROCESSING TO GENERATE PROJECT-BASED TRANSITION STATES

(71) Applicant: Dell Products L.P., Round Rock, TX (US)

(72) Inventors: Yvonne Cecile Carrier, West Boylston, MA (US); Shibi Panikkar, Bangalore (IN)

(21) Appl. No.: 18/106,625

(22) Filed: Feb. 7, 2023

(51) Int. Cl. G06F 8/77; G10L 15/18; G10L 15/22; G10L 15/30

(52) U.S. Cl. CPC G06F 8/77; G10L 15/1815; G10L 15/22; G10L 15/30

(57) ABSTRACT

Automated project management techniques are disclosed using conversational processing to generate project-based transition states in an information processing system. For example, a method generates a data structure representing a lifecycle of at least one goal of a given project, wherein the data structure comprises one or more transition states associated with the at least one goal, and wherein the transition states are automatically tracked against one or more time instances. The method then facilitates management of the given project based on the generated data structure.

### FIELD

The field relates generally to information processing systems, and more particularly to automated management in such information processing systems.

### BACKGROUND

Successful software projects are typically ones that are well managed. To manage a software project efficiently, the manager or development team must choose a software development methodology that will work best for the project at hand. All methodologies have different strengths and weaknesses and exist for different reasons. Two such management methodologies include agile project management and waterfall project management. Agile project management is an incremental and iterative management paradigm, while waterfall project management is a linear management paradigm. However, both models present technical challenges in various project scenarios.

### SUMMARY

Illustrative embodiments provide automated project management techniques using conversational processing to generate project-based transition states in an information processing system.

For example, in an illustrative embodiment, a method generates a data structure representing a lifecycle of at least one goal of a given project, wherein the data structure comprises one or more transition states associated with the at least one goal, and wherein the transition states are automatically tracked against one or more time instances. The method then facilitates management of the given project based on the generated data structure.

Advantageously, one or more illustrative embodiments overcome the above and other technical drawbacks associated with existing project management by providing automated and otherwise intelligent techniques for tracking and managing project-based transition states in order to facilitate efficient completion of a project with respect to the project stakeholder. While the techniques described herein are well suited for implementation with agile-waterfall hybrid models, it is to be appreciated that alternative embodiments are not intended to be limited to any particular project management model.

These and other illustrative embodiments include, without limitation, apparatus, systems, methods and computer program products comprising processor-readable storage media.

### BRIEF DESCRIPTION OF THE DRAWINGS

FIG. 1 illustrates an agile model with which one or more illustrative embodiments can be implemented.

FIG. 2 illustrates an agile hierarchical structure with which one or more illustrative embodiments can be implemented.

FIG. 3 illustrates an agile-waterfall hybrid model with which one or more illustrative embodiments can be implemented.

FIG. 4 illustrates an automated project management system environment with epic transition state functionality according to an illustrative embodiment.

FIG. 5 illustrates a lifecycle data structure of epic transition states created and tracked via epic transition state functionality according to an illustrative embodiment.

FIG. 6 illustrates an epic transition state management environment according to an illustrative embodiment.

FIG. 7 illustrates a lifecycle data structure of epic transition states created and tracked via an epic transition manager module according to an illustrative embodiment.

FIG. 8 illustrates an automated project management methodology with epic transition state functionality according to an illustrative embodiment.

FIG. 9 illustrates an example of a processing platform that may be utilized to implement at least a portion of an information processing system for automated project management according to an illustrative embodiment.

### DETAILED DESCRIPTION

Illustrative embodiments will be described herein with reference to exemplary information processing systems and associated computers, servers, storage devices and other processing devices. It is to be appreciated, however, that embodiments are not restricted to use with the illustrative system and device configurations shown. Accordingly, the term “information processing system” as used herein is intended to be broadly construed, so as to encompass, for example, a processing system comprising one or more processing devices (i.e., computing resources) and one or more memory devices (i.e., storage resources). Some processing systems may also comprise communication or connectivity interface devices (i.e., network resources) to facilitate operations.

By way of example only, some information processing systems may comprise cloud computing and storage systems, as well as other types of processing systems comprising various combinations of physical and virtual processing resources. An information processing system may therefore comprise, for example, at least one data center (or part of a data center) or other type of cloud-based system that includes one or more clouds hosting tenants that access cloud resources. Such systems are considered examples of what are more generally referred to herein as cloud-based computing environments. Some cloud infrastructures are within the exclusive control and management of a given enterprise, and therefore are considered “private clouds.” The term “enterprise” as used herein is intended to be broadly construed, and may comprise, for example, one or more businesses, one or more corporations or any other one or more entities, groups, or organizations. An “entity” as illustratively used herein may be a person or system. On the other hand, cloud infrastructures that are used by multiple enterprises, and not necessarily controlled or managed by any of the multiple enterprises but rather respectively controlled and managed by third-party cloud providers, are typically considered “public clouds.” Enterprises can choose to host their applications or services on private clouds, public clouds, and/or a combination of private and public clouds (hybrid clouds) with a vast array of computing resources attached to or otherwise a part of the infrastructure. Numerous other types of enterprise computing and storage systems are also encompassed by the term “information processing system” as that term is broadly used herein.

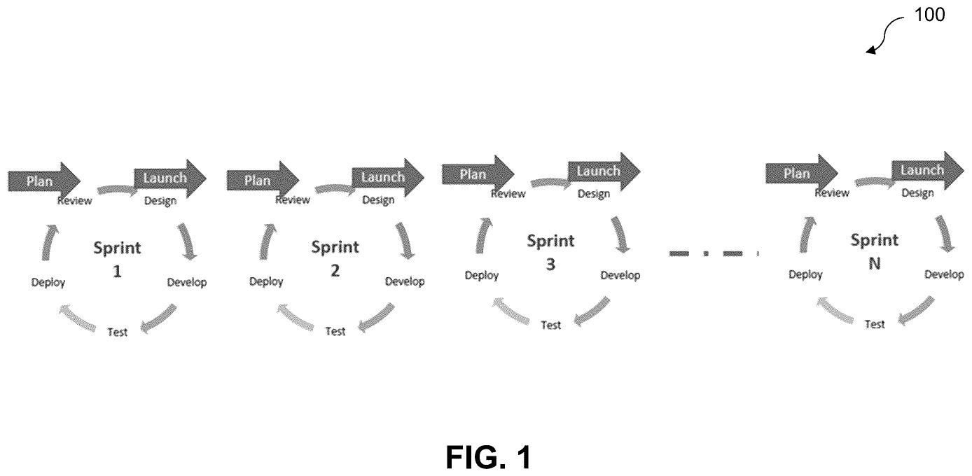

Referring initially to FIG. 1, an agile model 100 is depicted. As mentioned, agile project management is an incremental and iterative management paradigm. Agile model 100, as shown, corresponds to a given project, such as a software product development project undertaken by a given enterprise, that can be managed in iterations or sprints. For example, each sprint in agile model 100 (Sprint 1, Sprint 2, . . . , Sprint N) represents a product development cycle comprising a product part, a product design part, a product develop part, a product test part, a product deploy part, a product review part, and a product launch part. In a software product development context, planning, designing, developing, testing, deploying, reviewing, and launching would correspond to the stages of a software product development lifecycle being managed. Of course, the same or a similar set of stages and lifecycle parts could apply to a hardware product, a product containing a combination of hardware and software, or any other product.

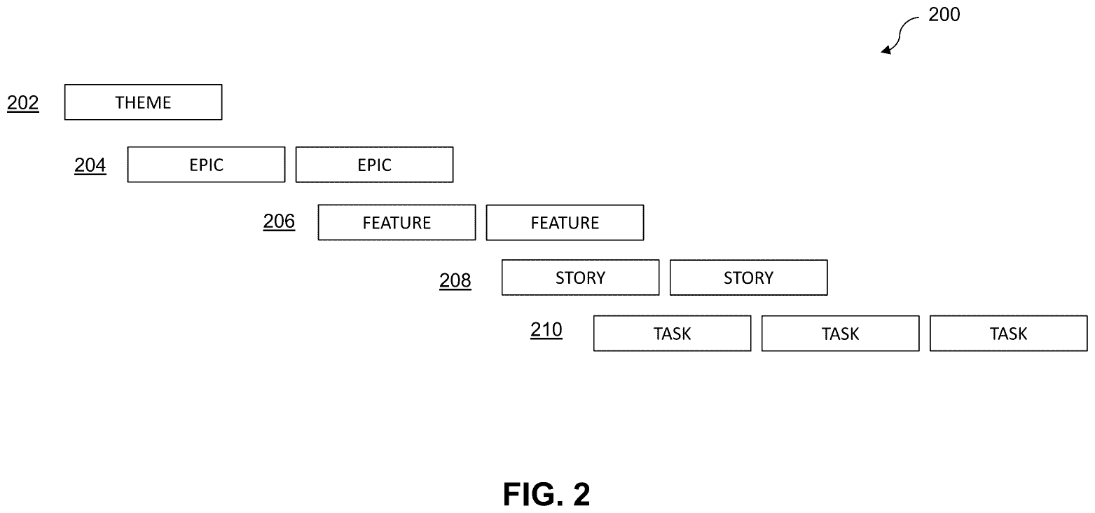

Agile project management can also be visualized in terms of a hierarchical structure with multiple levels corresponding to conceptual terms referred to as: a theme; an epic; a feature; a story; and a task. FIG. 2 illustrates an agile hierarchical structure 200 with a theme level 202 comprising a theme, an epic level 204 comprising one or more epics, a feature level 206 comprising one or more features, a story level 208 comprising one or more stories, and a task level 210 comprising one or more tasks.

A theme is typically simply a label given to the main organizational goal of the project team. Epics refer to work (or goals) sections that can be delivered over or more sprints that collectively attempt to achieve the theme, or at least some aspect that will lead to the goal of the theme. Features are subsections of the work (goals) associated with a given epic. Stories are subsections of the work (goals) associated with a given feature. Tasks are subsections of the work (goals) associated with a story.

For example, in the software context, a theme could be for an enterprise to develop a deliverable software product for one or more customers. Epics can then represent the work or goals associated with aspects of the software product and thus may be considered sections of work or goals that strategically add value. Epics can be broken down into specific sections of work or goals called features which can be based on the needs/requests of end users, which can then be broken down even further into stories, and then even further into tasks.

Accordingly, in agile hierarchical structure 200, assume requirements are created in blocks as epics. Epics are usually considered the top level of the portion of the hierarchy (i.e., agile hierarchical structure 200) associated with actual work efforts. Epics are usually broad in scope and are meant to be split into multiple, smaller features, then stories, then tasks, before they can be worked on.

Assume that the project is managed via an information processing system associated with an enterprise. For example, agile model 100 is implemented in the information processing system and the theme, epics, features, stories, and tasks of agile hierarchical structure 200 are authored and tracked by project stakeholders of the enterprise via the information processing system.

Now assume, for example, that a given epic in the context of a software product will be in production on Sprint 3 (FIG. 1). Even though there will be continuous deployment in Sprints 1 and 2, assume that the entire testing will be done at Sprint 3 for the given epic, and that the given epic will be visible in production to the customer. Thus, this management project is relatively easy to track via the information processing system.

However, while agile project management is suitable based on the nature of software development, a pure agile process is not always feasible for various reasons, e.g., numerous application interlocks, specific commitment to the customer on a date, vendor products, seasonal sales, to name few. Thus, a hybrid model that combines aspects of the agile and waterfall paradigms, i.e., an agile-waterfall hybrid model, can be followed in certain circumstances.

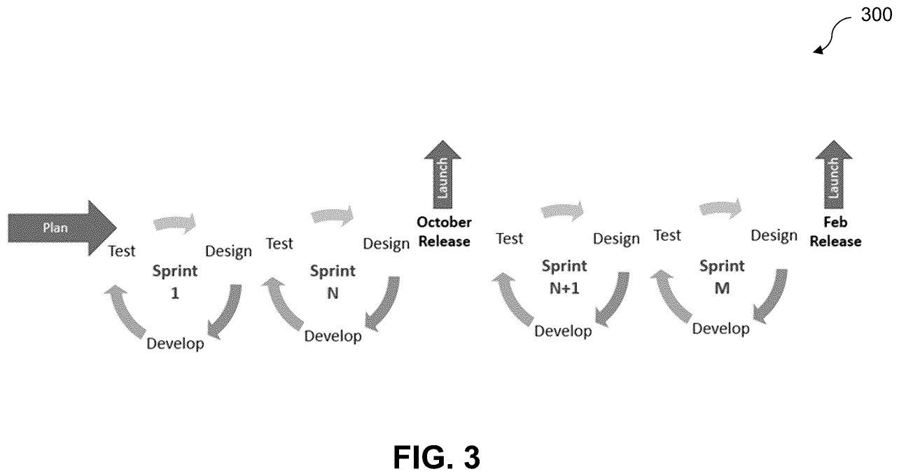

More particularly, FIG. 3 illustrates an agile-waterfall hybrid model 300. In this particular model of a product development scenario, it is assumed that planning is done upfront for a release and an epic is authored and intended to occur over Sprint 1 through Sprint N, with an expectation that the epic will be delivered (launch) in an October release. Here a problematic gap in the process starts, as demonstrated by the following example.

Consider an illustrative epic that is written as follows: “As a sales agent, I want to login to the offline sales tool and view all subscription offers and configure them.”

Acceptance criteria for this epic could comprise:
1. Sales agent able to login;
2. View the relevant catalog and offers marked for the particular sales agent;
3. Select the offer;
4. Perform the vendor validation for that offer;
5. Sales agent configures the offer;
6. Get the rate card for the price for the selection; and
7. Sales agent creates the quote.

So in an enterprise/customer use case, the business management (Business or Business Transformation Office/BTO) typically creates this above epic in the associated information processing system in which agile-waterfall hybrid model 300 is implemented, which is then passed to a program manager (PM). The program manager then starts communicating with the leaders of the technical team (Architects and/or Engineering) how to make this epic happen. Assume further that communication between these stakeholders is accomplished through one or more communication interfaces (e.g., conversation mechanisms such as a chat platform or discussion forum) implemented by the information processing system. Here the real technical issue starts. Due to the release window, the technical team may not be able to deliver each of the seven parts of the above acceptance criteria as written. The technical team will start putting questions in the discussion forum. By way of example only, the chat may go as follows:
Engineering: Do we need the country-based catalog?
PM: Yes
Engineering: I don't think we can deliver the country-based catalog in the 0822 release. We may have to make it a static global catalog for now.
PM: Ok
Engineering: Another clarification needed. We will not be able to deliver the vendor validations for this release. We need to make sure the customer is entering genuine ID for this release.
PM: @Business/BTO. Please confirm.
Business/BTO: Sure. Go ahead.

Further assume that no project stakeholder bothered to track this chat outcome. As a result, when the end-to-end testing is done, testing will follow the acceptance criteria defined for the epic (i.e., the seven requirements listed above) rather than the adjusted criteria agreed to in the above chat, and a defect will be raised. This leads to significant churn and the need for executive discussions.

Sometimes Business/BTO, itself, writes new acceptance criteria (e.g., locally in an Excel spreadsheet) for this release that are not defined in the epic. The Engineering will go ahead and create the features and tasks and deliver the epic. Assume then that Business/BTO uses the new local acceptance criteria to do the testing. This might be fine since the testing will follow the adjusted acceptance criteria, however, the manual and untracked nature of this change can result in other stakeholders being unaware of the change.

However, returning to the above written epic (with the seven acceptance criteria), a question is: did this epic implement in the August 2022 (0822) release? The answer is yes and no since about 60% of the epic was completed. But what part of the epic was completed by the first release and what part is pending. Existing project management approaches implemented in information processing systems do not currently track this information as they have no mechanism for doing so. This may not always present an issue in a pure agile model (FIG. 1), as whatever is being implemented can be treated as a sprint to achieve the final epic goal. However, in an agile-waterfall hybrid model (FIG. 3), after the first release, it is realized herein that there is a need to track what parts of the epic are implemented and what parts are not.

Illustrative embodiments overcome the above and other technical drawbacks associated with existing project management approaches implemented on information processing systems by introducing a concept of epic transition states, wherein the information processing system is configured to track incremental (transition) changes that are being performed in different releases before reaching the final goal of the epic. Further, illustrative embodiments provide an automated methodology for recommending different epic transitions with new acceptance criteria by automatically reading the appropriate forum discussion and automatically creating the epic transition while maintaining the relationship with the final state. Still further, the automated methodology may recommend a percent weightage of completeness in each epic transition with respect to the main epic.

Advantageously, illustrative embodiments provide for technical solutions, in the context of an agile-waterfall hybrid model of development wherein an epic may need to be implemented in different stages in a release cycle, for tracking changes (transitions) to the epic. Illustrative embodiments accomplish this and other advantages by introducing the epic transition states concept in the agile-waterwall hybrid model. For example, implementing the epic transition state functionality in the agile-waterwall hybrid model according to one or more illustrative embodiments enables the tracking of delivery in iterations (sprints) but also enables implementation of a release window to release the developed capabilities to production.

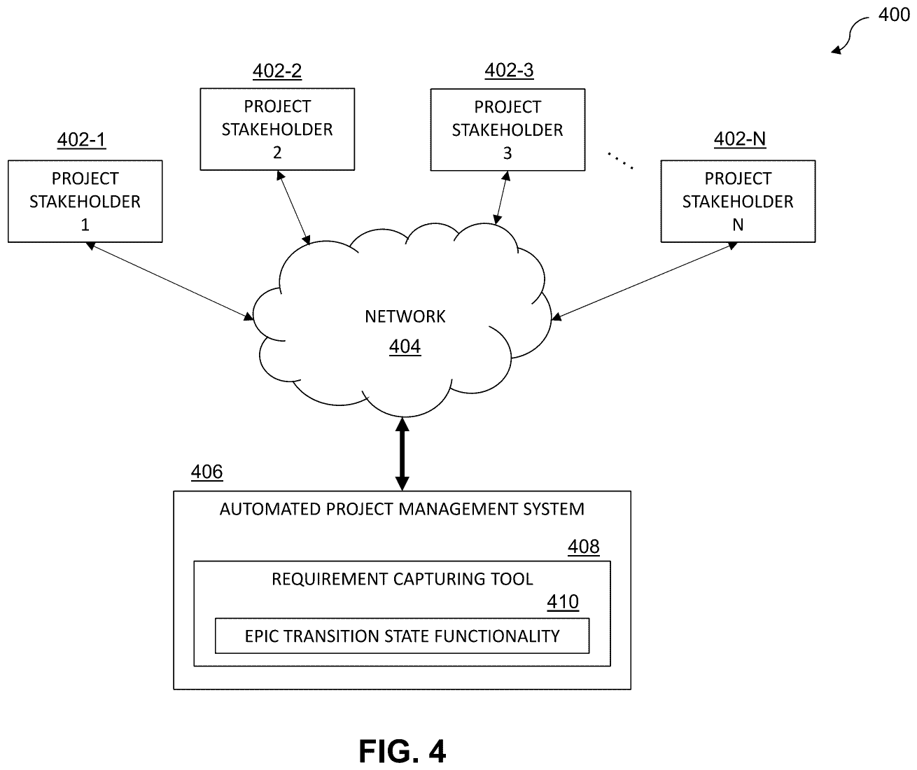

Referring now to FIG. 4, an information processing system environment 400 is shown with epic transition state functionality according to an illustrative embodiment. As shown, information processing system environment 400 comprises a plurality of project stakeholders 402-1, 402-2, 402-3, . . . , 402-N (collectively referred to hereinafter as project stakeholders 402 and individually as project stakeholder 402) operatively coupled to a network 404. In addition, an automated project management system 406 is also operatively coupled to network 404, and thereby each project stakeholder 402 is operatively coupled to automated project management system 406 through network 404. It is to be appreciated that one or more project stakeholders 402 can be directly connected to automated project management system 406 and/or via networks other than network 404.

Project stakeholders 402 can be any entity that participates in a given project being managed via automated project management system 406. By way of example, in the software development project scenario explained above, project stakeholders 402 may refer to entities such as, but not limited to, Business/BTO, PM, Engineering, etc. Network 404 may comprise any communication network described herein, or otherwise, that enables computing devices and/or other communication devices operated by project stakeholders 402 to locally and/or remotely access automated project management system 406. By way of example only, network 404 can be a public data network such as the Internet or public cloud, a private data network such as a private cloud or a localized network, a telecommunication network, or some combination thereof.

As further shown in FIG. 4, automated project management system 406 comprises a requirement capturing tool 408 and an epic transition state functionality 410. In this illustrative embodiment, epic transition state functionality 410 is implemented as a software plugin to requirement capturing tool 408. In one non-limiting example, requirement capturing tool 408 may comprise the Team Foundation Server (TFS) tool commercially available from Microsoft.

However, alternative embodiments are not limited to any specific requirement capturing tool 408 or implementation of epic transition state functionality 410 as a software plugin to requirement capturing tool 408. That is, epic transition state functionality 410 can be a standalone module executing in automated project management system 406, or some combination of a standalone and plugin module.

As will be further explained herein, epic transition state functionality 410 is configured to constantly monitor the discussions on a given epic and infer the intents of the chat sequences. Epic transition state functionality 410 is further configured to then suggest if the epic transition is needed using the intents derived. Once a user accepts the epic suggestion, epic transition state functionality 410 guides the user to assist in creating new epic transition state(s) and tracks the epic to a conclusion, thus overcoming technical drawbacks associated with existing approaches.

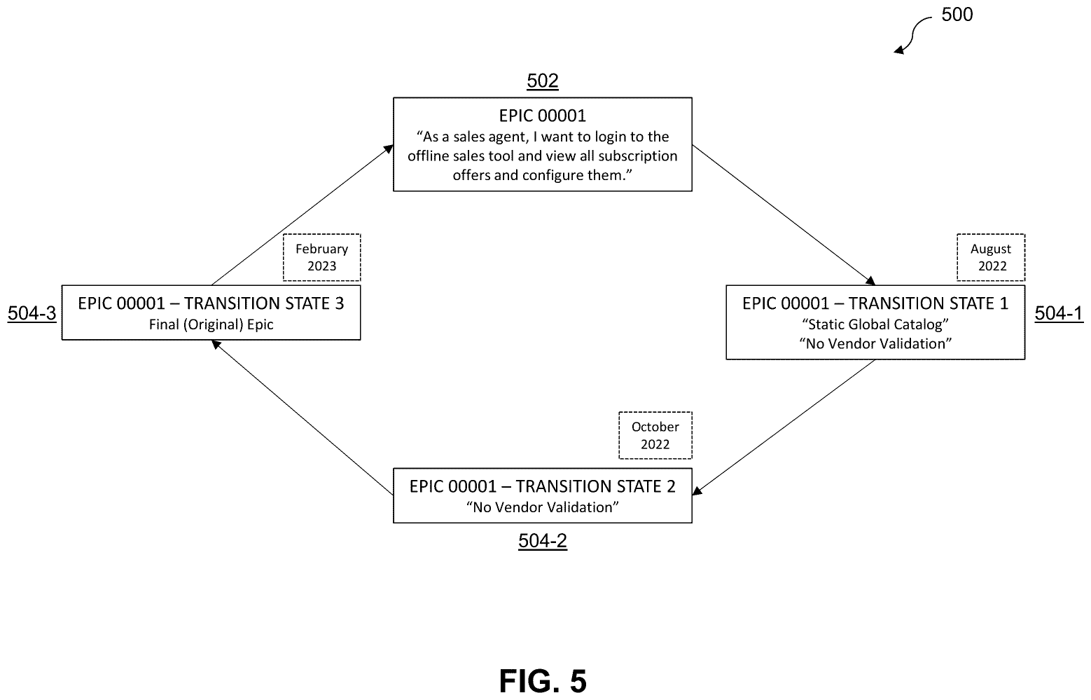

FIG. 5 illustrates a lifecycle data structure 500 of epic transition states created and tracked via epic transition state functionality 410 according to an illustrative embodiment. Assume the epic is the previously mentioned illustrative epic: “As a sales agent, I want to login to the offline sales tool and view all subscription offers and configure them.” Also, assume the same previous seven acceptance criteria for this epic.

Thus, as shown in FIG. 5, block 502 (EPIC 00001) is created via epic transition state functionality 410 and corresponds to the epic as originally authored. Following the discussion forum between project stakeholders (Business/BTO, PM, Engineering), recall that two exceptions occurred to the acceptance requirements during the discussion, i.e., that the catalog delivered would have to be a static global catalog not a country-based catalog and that no vendor validation would occur rather customer validation would be needed.

Block 504-1 (EPIC 00001—TRANSITION STATE 1) is therefore created via epic transition state functionality 410 and corresponds to the epic state at the time of a first product release (August 2022). Advantageously, transition state 1 in block 504-1 tracks the two acceptance criteria exceptions (i.e., static global catalog and no vendor validation) recorded prior to the first product release.

Now assume that prior to a second product release (October 2022), a country-specific catalog was made available, thus clearing the “static global catalog” exception. Thus, block 504-2 (EPIC 00001—TRANSITION STATE 2) is created via epic transition state functionality 410 and corresponds to the epic state at the time of the second product release.

Lastly, assume that prior to a third product release (February 2023), vendor validation was made available, thus clearing the “no vendor validation” exception. Thus, block 504-3 (EPIC 00001—TRANSITION STATE 3) is created via epic transition state functionality 410 and corresponds to the epic state at the time of the third product release. Note that the epic at transition state 3 is consistent with the originally authored epic represented by block 502 since all acceptance criteria have been achieved by the third product release date. As such, testing at each product release date will not fail since the acceptance criteria exceptions will be tracked and their statuses known by any testing entity (i.e., another project stakeholder 402) following each release.

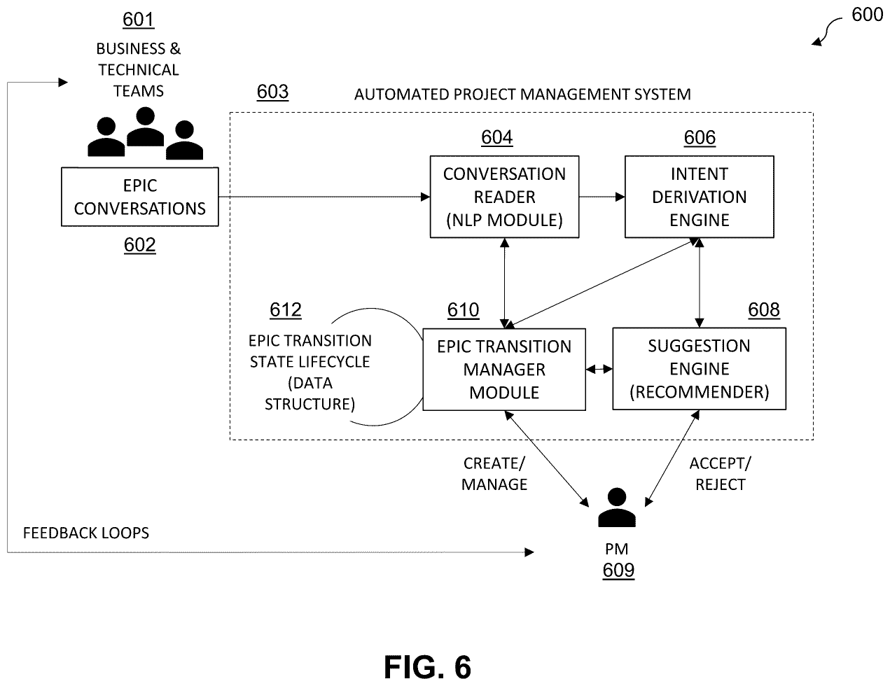

Turning now to FIG. 6, an epic transition state management environment 600 is depicted according to an illustrative embodiment. It is to be appreciated that epic transition state management environment 600 depicts one illustrative embodiment of epic transition state functionality 410 that is configured to track and otherwise manage epic transition states via a data structure such as illustratively depicted by lifecycle data structure 500.

As shown, business & technical teams 601 and a project manager (PM) 609 (i.e., project stakeholders 402) are operatively coupled to automated project management system 603 (e.g., corresponding to automated project management system 406 in FIG. 4). Automated project management system 603 comprises a conversation reader 604 (e.g., a natural language processing/NLP module), an intent derivation engine 606, a suggestion engine 608 (e.g., a recommender), an epic transition manager module 610, and an epic transition state lifecycle 612 (e.g., data structure). One or more of the modules in automated project management system 603 can implement one or more machine learning (ML) algorithms for performing functions described herein.

Conversations between the business and technical teams regarding a given epic and acceptance criteria corresponding thereto, i.e., epic conversations 602, are captured by conversation reader 604 which applies NLP techniques. Assume epic conversations 602 are the ones mentioned above in the running epic example (EPIC 00001) between Engineering, PM, and Business/BTO. Note that epic conversations 602 can be captured from voice calls, text exchanges, email exchanges, other forms of communication exchange, and combinations thereof. In whatever form epic conversations 602 are received by conversation reader 604, the discussions are converted to transcriptions, and NLP techniques are applied to the transcriptions. In one example, the Natural Language Toolkit (NLTK) can be used which is a set of libraries and programs for symbolic and statistical natural language processing for English written in the Python programming language. For example, NLTK is used to derive keywords that are helpful for intent derivation engine 606 to derive the intent.

More particularly, assume that the release date and name for the EPIC release is set by one of the project stakeholders. In the running example, the proposed EPIC release is August 2022 (e.g., Name: 082022, Date: Aug. 8, 2022). When epic conversations 602 are received, conversation reader 604 reads the conversations, and lemmatizes them to find risk words, negative words, verbs, etc. Lemmatization in linguistics is the process of grouping together the inflected forms of a word so they can be analyzed as a single item, identified by the word's lemma or dictionary form. Conversation reader 604 may, for example, mark a given one of epic conversations 602 as a potential “epic transition triggering conversation” as will be further explained herein. Conversation reader 604 passes the relevant verbs, risk words, negative words, etc. to intent derivation engine 606.

More specifically, consider the example discussion given above, repeated here for ease of reference:
Engineering: Do we need the country-based catalog?
PM: Yes
Engineering: I don't think we can deliver the country-based catalog in the 082022 release. We may have to make it a static global catalog for now.
PM: Ok
Engineering: Another clarification needed. We will not be able to deliver the vendor validations for this release. We need to make sure the customer is entering genuine ID for this release.
PM: (a Business BTO. Please confirm.
Business BTO: Sure. Go ahead.

First, conversation reader 604 converts any voice conversations into text, and along with any text conversations, performs a spell check correction for each transcription of the conversation. Conversation reader 604 lemmatizes the sentences into words and segregates the words based on labels such as, by way of example only, open questions, negative words, risk words, related verbs, related domain nouns. Examples of risk words may include: “may not be able to deliver;” “need clarification;” “can you please explain;” “requirement is not clear;” “need analysis;” “solution is not ready;” etc. Any number of other risk words can be added, and existing ones removed or modified. Examples of negative words may include: “will not be able to deliver;” “can deliver only next release;” “not possible in this release;” “we can deliver only xyz;” etc. Examples of verbs may include: “deliver;” “launch,” etc. Examples of domain nouns may include: “082022;” “next release;” “this release;” etc. Examples of open questions may include: a question from a previous conversation, a current question, etc.

Illustrative NLTK code that can be used by conversation reader 604 to spell check and lemmatize the input text may include:
tokenized_word=readText( )
for word in non_corrected_tokenized_word:
   tokenized_word.append(spell.correction(word))
lem=WordNetLemmatizer( )
lemmed_words=[ ]

Illustrative NLTK code that can be used by conversation reader 604 to obtain negative words may include:
for w in tokenized_word:
   lemmed_words.append(lem.lemmatize(w, “DT”))—DT to find the negative

Thus, considering the example discussion given above, one conversation turn at a time, results of conversation reader 604 may include:
Engineering: Do we need the country-based catalog?

Conversation reader 604 result: No negative words or risk words. However, this is a question. Therefore, label as open question.
PM: Yes

Conversation reader 604 result: No negative or risk words. Answered previous question. Remove previous question from open question category.
Engineering: I don't think we can deliver the country-based catalog in the 082022 release. We may have to make it a static global catalog for now.

Conversation reader 604 result:
Risk words—“may have to make”
Negative words—“don't think”
Verb—“deliver”
Domain Noun—082022 (Release name)

This conversation turn is therefore marked as “epic transition triggering conversation.”
Engineering: Another clarification needed. We will not be able to deliver the vendor validations for this release. We need to make sure the customer is entering genuine ID for this release.

Conversation reader 604 result:
Risk words—“clarification needed”
Negative words—“will not be able”
Verb—“deliver”
Domain Noun—“this release”

This conversation turn is therefore also marked as “epic transition triggering conversation.”

Following processing performed by conversation reader 604, any negative words, risk words, verbs, domain nouns, and epic transition triggering conversations are passed as keywords to intent derivation engine 606.

Intent derivation engine 606 derives various intents based on the received keywords. Intents can be categorized as follows:
“As planned” intent—if no negative words;
“Open question” intent—if any keywords labeled open question;
“Not able to deliver” intent—if sentence contains negative words (so called show-stopper words), critical verb (delivery) and noun (082022, this delivery, etc.); and
“Risk in delivery” intent—if sentence has risk words and supported with a need for further conversation for finalizing.

If the intent derived by intent derivation engine 606 is “as planned,” then no issues exist. If the intent derived by intent derivation engine 606 is “open question,” then this will need further consideration.

If intent derived by intent derivation engine 606 is “not able to deliver,” then PM 609 is alerted and creation of an epic transition is suggested and marked as “epic transition triggering conversation.”

If intent derived by intent derivation engine 606 is “risk in delivery,” then PM 609 is alerted that there is a need for a conversation with the stakeholder associated with the conversation turn and a decision made whether an epic transition is needed.

Intents derived by intent derivation engine 606, along with any conversations (one or more turns) marked as “epic transition triggering conversation,” are sent to suggestion engine 608. It is to be appreciated that all intents derived by intent derivation engine 606 can be sent to suggestion engine 608, or only the intents categorized as “open question,” “not able to deliver” and “risk in delivery.”

Suggestion engine 608 reads the intents and identifies any intents categorized as “not able to deliver,” “risk in delivery,” “open question” and “epic transition triggering conversation.” Suggestion engine 608 then lists the conversation turns with the above-identified intents and ranks them based on considerations comprising:
(i) As time (e.g., days) pass, ranking will increase (at a configurable increment).
(ii) More negative and risky conversations in chat increase the ranking.
(iii) If last conversation is “open question” and a threshold number of days is reached, it is marked as a risky epic and the intent is re-categorized as “risk in delivery.”
(iv) Once a threshold value (e.g., 10 but configurable) is reached, an alert is triggered to PM 609, who can log into epic transition manager module 610 which generates an epic transition state lifecycle (data structure) 612 useable to track and otherwise manage epic transition states and thereby the given epic.

Note that PM 609 and one or more business & technical teams 601 can communicate outside of automated project management system, as may be needed/desired, by one or more communication feedback loops as shown in FIG. 6. However, these additional communications can also be captured as epic conversations 602 and processed by conversation reader 604 as described herein.

Epic transition manager module 610 is configured to identify and show (via one or more user interfaces) to PM 609 the different epics that are in a “risk in delivery” category or a “not able to deliver” category and perform or enable performance of operations based on the category.

“Risk in delivery” epic management. More particularly, once PM 609 selects the risk in delivery category, the one or more user interfaces of epic transition manager module 610 show:
a) Author of the epic;
b) Description of the epic;
c) Acceptance criteria of the epic; and
d) Risky conversation(s) that is marked as “epic transition triggering conversation.” PM 609 can then take can take actions including, but not limited to:
a) Mark the epic as “good for release” if PM 609 is confident that irrespective of the risky conversation, the epic will be delivered;
b) Click on “start conversation” button on interface to meet the person(s) who provided the epic transition triggering conversion; and
c) Start epic transitioning.

“Not able to deliver” epic management. More particularly, this category almost certainly will lead to an epic transitioning operation. However, PM 609 can override that and mark it “good for release” or have conversations with the team to reach assurance.

Once PM 609 decides to initiate epic transitioning (e.g., selects an epic transitioning button on user interface), epic transition manager module 610 searches for and presents: (i) the epic transition triggering conversation; (ii) stakeholder who provided the conversation; (iii) the epic description; (iv) the epic acceptance criteria; (v) features defined under the epic; and (vi) tasks defined under the epic.

Once the above information is presented, PM 609 selects a create epic transition state lifecycle button on the user interface. PM 609 then selects how many epic transition states need to be created based on the release dates.

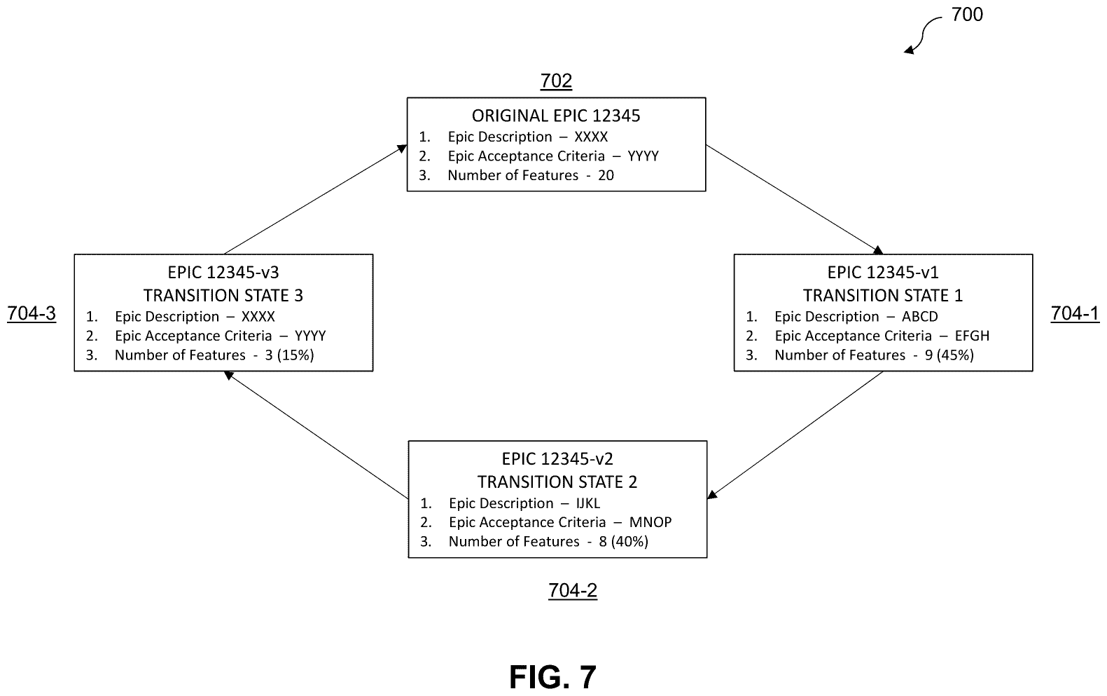

Epic transition manager module 610 then generates a data structure (epic transition state lifecycle 612) with that many epic transition states and labels them with version numbers (−v1, −v2, . . . ) appended to original epic number. FIG. 7 illustrates an illustrative epic transition state lifecycle 700 for a given epic. As shown, block 702 represents the original epic (EPIC 12345), while block 704-1 represents a first transition state of the given epic (EPIC 12345-v1), block 704-2 represents a second transition state of the given epic (EPIC 12345-v2), and block 704-3 represents a third transition state of the given epic (EPIC 12345-v3). Each transition state is mapped to the respective release dates. In each transition of the epic, the original epic details are copied along with the features (and tasks) under that epic. PM 609 can edit the epic details, acceptance criteria, and attaches relevant features (and tasks) for each transition state, as needed/desired. PM 609 can edit the release date as well. Advantageously, all project stakeholders can now follow the epic transition state lifecycle 612 to complete the original epic following the different release dates.

It is to be appreciated that epic transition manager module 610 can also assign a percent weightage of completeness in each epic transition state to epic transition state lifecycle 700 for the given epic (e.g., block 704-1 represents 9/20=45%; block 704-2 represents 8/20=40%; and block 704-3 represents 3/20=15%).

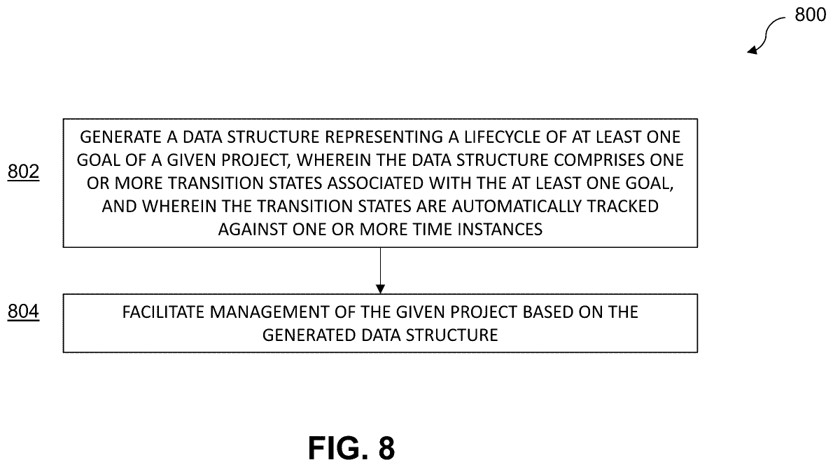

FIG. 8 summarizes an automated project management methodology 800 using conversational processing to generate project-based transition states, according to an illustrative embodiment. As shown, step 802 generates a data structure representing a lifecycle of at least one goal of a given project, wherein the data structure comprises one or more transition states associated with the at least one goal, and wherein the transition states are automatically tracked against one or more time instances. Step 804 then facilitates management of the project based on the generated data structure.

Illustrative embodiments are described herein with reference to exemplary information processing systems and associated computers, servers, storage devices and other processing devices. It is to be appreciated, however, that embodiments are not restricted to use with the illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Cloud infrastructure can include private clouds, public clouds, and/or combinations of private/public clouds (hybrid clouds).

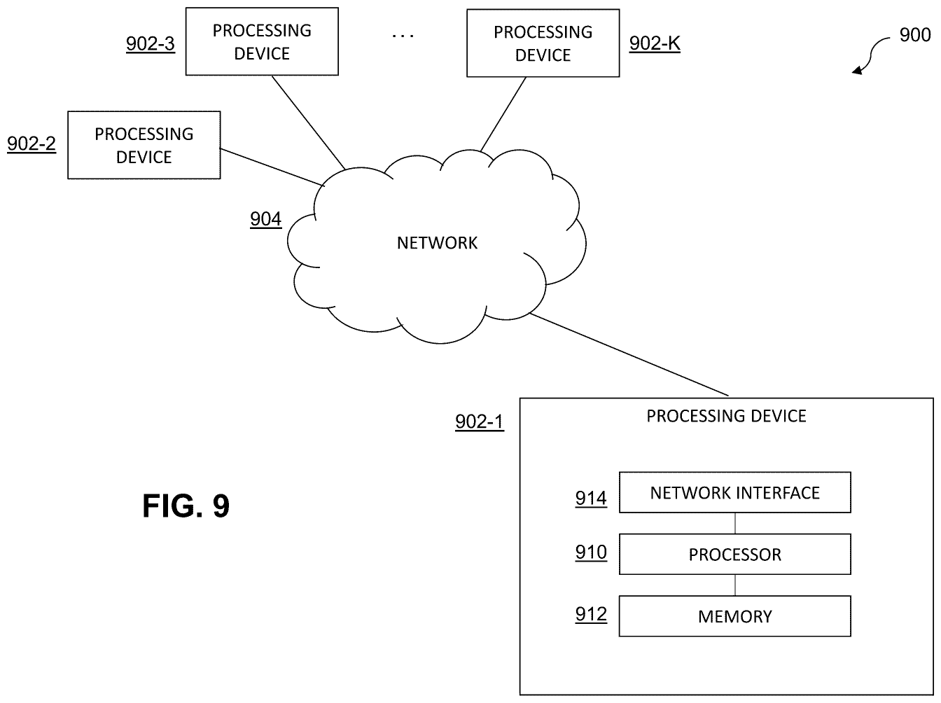

FIG. 9 depicts a processing platform 900 used to implement systems/processes/data depicted in FIGS. 1 through 8, respectively, according to an illustrative embodiment. More particularly, processing platform 900 is a processing platform on which a computing environment with functionalities described herein can be implemented.

The processing platform 900 in this embodiment comprises a plurality of processing devices, denoted 902-1, 902-2, 902-3, . . . 902-K, which communicate with one another over network(s) 904. It is to be appreciated that the methodologies described herein may be executed in one such processing device 902, or executed in a distributed manner across two or more such processing devices 902. It is to be further appreciated that a server, a client device, a computing device or any other processing platform element may be viewed as an example of what is more generally referred to herein as a “processing device.” As illustrated in FIG. 9, such a device generally comprises at least one processor and an associated memory, and implements one or more functional modules for instantiating and/or controlling features of systems and methodologies described herein. Multiple elements or modules may be implemented by a single processing device in a given embodiment. Note that components described in the architectures depicted in the figures can comprise one or more of such processing devices 902 shown in FIG. 9. The network(s) 904 represent one or more communications networks that enable components to communicate and to transfer data therebetween, as well as to perform other functionalities described herein.

The processing device 902-1 in the processing platform 900 comprises a processor 910 coupled to a memory 912. The processor 910 may comprise a microprocessor, a microcontroller, an application-specific integrated circuit (ASIC), a field programmable gate array (FPGA) or other type of processing circuitry, as well as portions or combinations of such circuitry elements. Components of systems as disclosed herein can be implemented at least in part in the form of one or more software programs stored in memory and executed by a processor of a processing device such as processor 910. Memory 912 (or other storage device) having such program code embodied therein is an example of what is more generally referred to herein as a processor-readable storage medium. Articles of manufacture comprising such computer-readable or processor-readable storage media are considered embodiments of the invention. A given such article of manufacture may comprise, for example, a storage device such as a storage disk, a storage array or an integrated circuit containing memory. The term “article of manufacture” as used herein should be understood to exclude transitory, propagating signals.

Furthermore, memory 912 may comprise electronic memory such as random-access memory (RAM), read-only memory (ROM) or other types of memory, in any combination. The one or more software programs when executed by a processing device such as the processing device 902-1 causes the device to perform functions associated with one or more of the components/steps of system/methodologies in FIGS. 1 through 8. One skilled in the art would be readily able to implement such software given the teachings provided herein. Other examples of processor-readable storage media embodying embodiments of the invention may include, for example, optical or magnetic disks.

Processing device 902-1 also includes network interface circuitry 914, which is used to interface the device with the network(s) 904 and other system components. Such circuitry may comprise conventional transceivers of a type well known in the art.

The other processing devices 902 (902-2, 902-3, . . . 902-K) of the processing platform 900 are assumed to be configured in a manner similar to that shown for computing device 902-1 in the figure.

The processing platform 900 shown in FIG. 9 may comprise additional known components such as batch processing systems, parallel processing systems, physical machines, virtual machines, virtual switches, storage volumes, etc. Again, the processing platform shown in this figure is presented by way of example only, and the system shown as 900 in FIG. 9 may include additional or alternative processing platforms, as well as numerous distinct processing platforms in any combination.

Also, numerous other arrangements of servers, clients, computers, storage devices or other components are possible in processing platform 900. Such components can communicate with other elements of the processing platform 900 over any type of network, such as a wide area network (WAN), a local area network (LAN), a satellite network, a telephone or cable network, or various portions or combinations of these and other types of networks.

Furthermore, it is to be appreciated that the processing platform 900 of FIG. 9 can comprise virtual (logical) processing elements implemented using a hypervisor. A hypervisor is an example of what is more generally referred to herein as “virtualization infrastructure.” The hypervisor runs on physical infrastructure. As such, the techniques illustratively described herein can be provided in accordance with one or more cloud services. The cloud services thus run on respective ones of the virtual machines under the control of the hypervisor. Processing platform 900 may also include multiple hypervisors, each running on its own physical infrastructure. Portions of that physical infrastructure might be virtualized.

As is known, virtual machines are logical processing elements that may be instantiated on one or more physical processing elements (e.g., servers, computers, processing devices). That is, a “virtual machine” generally refers to a software implementation of a machine (i.e., a computer) that executes programs like a physical machine. Thus, different virtual machines can run different operating systems and multiple applications on the same physical computer. Virtualization is implemented by the hypervisor which is directly inserted on top of the computer hardware in order to allocate hardware resources of the physical computer dynamically and transparently. The hypervisor affords the ability for multiple operating systems to run concurrently on a single physical computer and share hardware resources with each other.

It was noted above that portions of the computing environment may be implemented using one or more processing platforms. A given such processing platform comprises at least one processing device comprising a processor coupled to a memory, and the processing device may be implemented at least in part utilizing one or more virtual machines, containers or other virtualization infrastructure. By way of example, such containers may be Docker containers or other types of containers.

The particular processing operations and other system functionality described in conjunction with FIGS. 1-9 are presented by way of illustrative example only, and should not be construed as limiting the scope of the disclosure in any way. Alternative embodiments can use other types of operations and protocols. For example, the ordering of the steps may be varied in other embodiments, or certain steps may be performed at least in part concurrently with one another rather than serially. Also, one or more of the steps may be repeated periodically, or multiple instances of the methods can be performed in parallel with one another.

It should again be emphasized that the above-described embodiments of the invention are presented for purposes of illustration only. Many variations may be made in the particular arrangements shown. For example, although described in the context of particular system and device configurations, the techniques are applicable to a wide variety of other types of data processing systems, processing devices and distributed virtual infrastructure arrangements. In addition, any simplifying assumptions made above in the course of describing the illustrative embodiments should also be viewed as exemplary rather than as requirements or limitations of the invention.

What is claimed is:

1. An apparatus comprising:
at least one processing device comprising a processor coupled to a memory, the at least one processing device, when executing program code, is configured to:
generate a data structure representing a lifecycle of at least one goal of a given project, wherein the data structure comprises one or more transition states associated with the at least one goal, and wherein the transition states are automatically tracked against one or more time instances; and
facilitate management of the given project based on the generated data structure.

2. The apparatus of claim 1, wherein, in generating the data structure, the at least one processing device, when executing program code, is further configured to receive a transcription of a conversation relating to the at least one goal of the given project, wherein the conversation corresponds to a plurality of project stakeholders.

3. The apparatus of claim 2, wherein, in generating the data structure, the at least one processing device, when executing program code, is further configured to process the transcription to generate one or more keywords in the conversation.

4. The apparatus of claim 3, wherein processing the transcription to generate one or more keywords in the conversation further comprises execution of one or more natural processing language algorithms.

5. The apparatus of claim 3, wherein, in generating the data structure, the at least one processing device, when executing program code, is further configured to derive one or more intents from the one or more generated keywords.

6. The apparatus of claim 5, wherein, in generating the data structure, the at least one processing device, when executing program code, is further configured to suggest the one or more transition states associated with the at least one goal based on the one or more derived intents.

7. The apparatus of claim 6, wherein suggesting the one or more transition states associated with the at least one goal based on the one or more derived intents further comprises utilizing the one or more derived intents to determine that one or more criteria associated with the at least one goal will not be met.

8. The apparatus of claim 6, wherein, in generating the data structure, the at least one processing device, when executing program code, is further configured to construct the data structure comprising a first block representing the at least one goal and one or more additional blocks, sequentially connected with the first block, representing the one or more transition states.

9. The apparatus of claim 8, wherein, in constructing the one or more additional blocks of the data structure, the at least one processing device, when executing program code, is further configured to enable at least one of the plurality of project stakeholders to edit information associated with the one or more additional blocks.

10. The apparatus of claim 8, wherein each of the one or more additional blocks comprises a unique sequential version number.

11. The apparatus of claim 8, wherein each of the one or more additional blocks comprises a value corresponding to a percent of completion of the at least one goal associated with the corresponding one or more transition states.

12. The apparatus of claim 1, wherein the one or more time instances correspond to one or more release dates of a product of the given project.

13. The apparatus of claim 1, wherein the given project is managed in accordance with an agile-waterfall hybrid model.

14. A method comprising:
generating a data structure representing a lifecycle of at least one goal of a given project, wherein the data structure comprises one or more transition states associated with the at least one goal, and wherein the transition states are automatically tracked against one or more time instances; and
facilitate management of the given project based on the generated data structure;
wherein the generating and managing steps are performed by at least one processing device comprising a processor coupled to a memory when executing program code.

15. The method of claim 14, wherein generating the data structure further comprises:
receiving a transcription of a conversation relating to the at least one goal of the given project, wherein the conversation corresponds to a plurality of project stakeholders;
processing the transcription to generate one or more keywords in the conversation;
deriving one or more intents from the one or more generated keywords; and
suggesting the one or more transition states associated with the at least one goal based on the one or more derived intents.

16. The method of claim 14, wherein the one or more time instances correspond to one or more release dates of a product of the given project.

17. The method of claim 14, wherein the given project is managed in accordance with an agile-waterfall hybrid model.

18. A computer program product comprising a non-transitory processor-readable storage medium having stored therein program code of one or more software programs, wherein the program code when executed by at least one processing device cause the at least one processing device to:
generate a data structure representing a lifecycle of at least one goal of a given project, wherein the data structure comprises one or more transition states associated with the at least one goal, and wherein the transition states are automatically tracked against one or more time instances; and
facilitate management of the given project based on the generated data structure.

19. The computer program product of claim 18, wherein generating the data structure further comprises:
receiving a transcription of a conversation relating to the at least one goal of the given project, wherein the conversation corresponds to a plurality of project stakeholders;
processing the transcription to generate one or more keywords in the conversation;
deriving one or more intents from the one or more generated keywords; and
suggesting the one or more transition states associated with the at least one goal based on the one or more derived intents.

20. The computer program product of claim 18, wherein the given project is managed in accordance with an agile-waterfall hybrid model.
